(19) United States
(12) Patent Application Publication
(10) Pub. No.: US 2024/0104394 A1
(43) Pub. Date: Mar. 28, 2024

(54) Platform for Automatic Production of Machine Learning Models and Deployment Pipelines

(71) Applicant: Google LLC, Mountain View, CA (US)

(72) Inventors: Amy Skerry-Ryan, Mountain View, CA (US); Quentin Lascombes de Laroussilhe, Zurich (CH); Ronald Rong Yang, Cupertino, CA (US); Carla Marie Riggi, Richmond, CA (US); Chansoo Lee, Pittsburgh, PA (US); Jordan Arthur Grimstad, Zurich (CH); Christopher Mark Lamb, San Francisco, CA (US); Joseph Michael Moran, Arlington, MA (US); Nihesh Anderson Klutto Milleth, Mountain View, CA (US); Noah Weston Hadfield-Menell, San Francisco, CA (US); Volodymyr Shtenovych, Zurich (CH); Ziqi Huang, Mountain View, CA (US); Sagi Perel, Irvine, CA (US); Michael David Gerard, Orange, CA (US); Mehadi Seid Hassen, Milpitas, CA (US)

(21) Appl. No.: 18/012,387

(22) PCT Filed: Mar. 11, 2022
(86) PCT No.: PCT/US2022/019982

§ 371 Date: Dec. 22, 2022

(51) Int. Cl. G06N 3/10; G06N 3/045; G06N 3/08

(52) U.S. Cl. CPC G06N 3/10; G06N 3/045; G06N 3/08

(57) ABSTRACT

Provided are computing systems, methods, and platforms that automatically produce production-ready machine learning models and deployment pipelines from minimal input information such as a raw training dataset. In particular, one example computing system can import a training dataset associated with a user. The computing system can execute an origination machine learning pipeline to perform a model architecture search that selects and trains a machine learning model for the training dataset. Execution of the origination machine learning pipeline can also result in generation of a deployment machine learning pipeline configured to enable deployment of the machine learning model (e.g., running the machine learning model to produce inferences and/or optionally other tasks such as re-training and/or re-tuning the model). The computing system can export the machine learning model and the deployment machine learning pipeline for deployment of the machine learning model with the deployment machine learning pipeline

### FIELD

The present disclosure relates generally to machine learning. More particularly, the present disclosure relates to computing systems, methods, and platforms that automatically produce production-ready machine learning models and deployment pipelines from minimal input information such as a raw training dataset.

### BACKGROUND

Machine learning is a field of computer science that includes the building and training (e.g., via application of one or more learning algorithms) of analytical models that are capable of making useful predictions or inferences on the basis of input data. Machine learning is based on the idea that systems can learn from data, identify patterns, and make decisions with minimal human intervention.

Various machine learning libraries exist which assist software developers in generating and deploying machine learning models. In particular, in computer science, a library is a collection of non-volatile resources used by computer programs, often for software development. These may include configuration data, documentation, help data, message templates, pre-written code and subroutines, classes, values, or type specifications.

A software developer or other user or individual can interact with a software library to build and deploy a machine learning pipeline. A machine learning pipeline can include computer-readable code that automates the workflow it takes to produce and/or deploy a machine learning model. Machine learning pipelines can include multiple sequential steps that do everything from data extraction and preprocessing to model training and deployment.

However, building and/or deploying a machine learning pipeline can be a challenging and time-consuming task. In particular, while certain existing machine learning libraries or other tools provide powerful components that span the entire machine learning workflow, these resources are often highly complex and may be accessible only to individuals or teams with a high level of infrastructure sophistication and engineering resources to invest into data wrangling, pipeline configuration & architecture, and modeling decisions.

While for certain sophisticated users this level of complexity may be workable, a large number of software developers or other users do not have the level of expertise to easily use such complicated resources. Further, even for sophisticated users, designing, training, and deploying a machine learning model with an associated deployment pipeline can require a significant amount of time, such as weeks to months. Therefore, improved systems which facilitate the development of machine learning models are desired.

### SUMMARY

Aspects and advantages of embodiments of the present disclosure will be set forth in part in the following description, or can be learned from the description, or can be learned through practice of the embodiments.

According to an example embodiment, a computing system for automatic production of machine learning models and corresponding deployment pipelines can include one or more processors. The computing system can further include one or more non-transitory computer-readable media that collectively store instructions that, when executed by the one or more processors, cause the computing system to perform operations. The operations can include importing a training dataset associated with a user. The operations can further include executing an origination machine learning pipeline to perform a model architecture search that selects and trains a machine learning model for the training dataset. The operations can further include executing the origination machine learning pipeline to generate a deployment machine learning pipeline for deployment of the machine learning model. The operations can further include exporting the machine learning model and the deployment machine learning pipeline for deployment of the machine learning model with the deployment machine learning pipeline.

According to another example embodiment, a computer-implemented method for automatic production of machine learning models and corresponding deployment pipelines can be performed by one or more computing devices and can include importing a training dataset associated with a user. The computer-implemented method can further include executing an origination machine learning pipeline. Executing the origination machine learning pipeline can include performing a model architecture search that selects and trains a machine learning model for the training dataset. Executing the origination machine learning pipeline can further include generating a deployment machine learning pipeline for deployment of the machine learning model. The computer-implemented method can further include exporting the machine learning model and the deployment machine learning pipeline for deployment of the machine learning model with the deployment machine learning pipeline.

According to another example embodiment, one or more non-transitory computer-readable media can collectively store instructions that, when executed by one or more processors of a computing system, cause the computing system to perform operations. The operations can include importing a training dataset associated with a user. The operations can further include executing an origination machine learning pipeline to perform a model architecture search that selects and trains a machine learning model for the training dataset. The operations can further include executing the origination machine learning pipeline to generate a deployment machine learning pipeline for deployment of the machine learning model. The operations can further include exporting the machine learning model and the deployment machine learning pipeline for deployment of the machine learning model with the deployment machine learning pipeline.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of implementations directed to one of ordinary skill in the art is set forth in the specification, which makes reference to the appended figures, in which:

FIG. 1 depicts a block diagram of an example origination machine learning pipeline according to example implementations of the present disclosure.

FIG. 2 depicts a block diagram of an example origination machine learning pipeline according to example implementations of the present disclosure.

FIG. 3 depicts a block diagram of an example deployment machine learning pipeline according to example implementations of the present disclosure.

FIG. 4 depicts a block diagram of an example deployment machine learning pipeline according to example implementations of the present disclosure.

FIG. 5A depicts a block diagram of an example computing system according to example implementations of the present disclosure.

FIG. 5B depicts a block diagram of an example computing device according to example implementations of the present disclosure.

FIG. 5C depicts a block diagram of an example computing device according to example implementations of the present disclosure.

Reference numerals that are repeated across plural figures are intended to identify the same features in various implementations.

### DETAILED DESCRIPTION

### Overview

Generally, the present disclosure is directed to computing systems, methods, and platforms that automatically produce production-ready machine learning models and deployment pipelines from minimal input information such as a raw training dataset. In particular, one example computing system can import a training dataset associated with a user. The computing system can execute an origination machine learning pipeline to perform a model architecture search that selects and trains a machine learning model for the training dataset. Execution of the origination machine learning pipeline can also result in generation of a deployment machine learning pipeline configured to enable deployment of the machine learning model (e.g., running the machine learning model to produce inferences and/or optionally other tasks such as re-training and/or re-tuning the model). The computing system can export the machine learning model and the deployment machine learning pipeline for deployment of the machine learning model with the deployment machine learning pipeline.

Thus, a user can provide only minimal input information such as the training dataset and, in return, the computing system can supply the user (or another system specified by the user) with a trained model (e.g., having an architecture identified through performance of the model architecture search) and also a deployment machine learning pipeline which has already been configured to handle and effectuate deployment of the trained model. Further, in some implementations, the deployment machine learning pipeline can be optionally editable or re-configurable by the user (e.g., an expert user) to directly manage the auto-constructed pipeline. However, in some implementations, users are generally not required to manage, edit, or control the pipeline or associated hyperparameters or code.

The proposed systems provide large value to entry-level users because many product teams, infrastructure teams, and analysts want to deploy machine learning for their use cases, but do not have the necessary infrastructure expertise to facilitate development of a full deployment machine learning (ML) pipeline. An automated, end-to-end flow can help these users easily make the jump from no-ML to basic-ML, which is historically the most significant increase in value.

The proposed systems can also be useful for sophisticated users. As discussed elsewhere herein, designing architectures requires a lot of expert knowledge and takes ample time, consuming weeks to months in some examples. Starting with the proposed systems and exiting to a full pre-configured machine learning pipeline will significantly reduce the time to a working pipeline and the time to a reasonably smart baseline model. From there, sophisticated users can tweak all parts of the deployment pipeline directly (e.g., unlike model-only solutions).

In another example aspect, some or all of the functionality described herein can be requested and executed via an application programming interface (API). For example, an ML platform that provides ML services for various users can request and receive the model and pipeline generation services described herein from the proposed systems via the API. Such an API can make it possible to create/delete a pipeline or invoke tasks, all while requiring little to no submission of additional code beyond the example inputs described above. Thus, the proposed system in combination with an API can allow developers of ML platforms to automatically request and receive pipelines that automate model construction with minimal code and configuration efforts. Further, entire platforms can be built on top of the programmatic API to build vertical automated machine learning solutions that tailor to a specific use case.

The systems and methods of the present disclosure provide a number of technical effects and benefits. As one example technical effect, the systems and methods described herein provide a fully automated origination ML pipeline that automatically performs an end-to-end development process by generating both a trained model and a deployment ML pipeline from only an initial dataset supplied by the user. Thus, a highly optimized origination pipeline can quickly and efficiently generate a high performing model and all the necessary companion code to enable quick and efficient deployment of the model. As such, model developers do not need to spend significant amounts of time and computational resources training and evaluating different model architecture to identify a suitable model. Instead, the highly efficient learning algorithms performed by the origination ML pipeline can quickly identify a suitable result. This more efficient architecture search (e.g., versus a manual trial and error approach) conserves computational resources such as computer processor usage, memory usage, and network bandwidth usage.

Another example aspect of the present disclosure is directed to an improved benchmarking system. The benchmarking system can be used with the automated model and pipeline generation tools described herein but can also be used by any other models or systems. In particular, example model benchmarking systems provided by the present disclosure can include a large number (e.g., hundreds, thousands, etc.) of different datasets (e.g., training datasets, validation datasets, etc.) and associated metadata that correspond to a number of different machine-learning tasks (e.g., classification tasks, generative tasks, vision tasks, etc.) or domains (e.g., imagery, text, audio, natural language, sensor data, statistical data, etc.). As examples, the metadata associated with each dataset can include: (a) properties of the dataset; (b) problem statements; (c) feature engineering transformations; (d) hyperparameter search space; (e) training logs and signals; and/or (f) model quality metrics associated with each combination of hyperparameters.

These datasets can be stored in a database and can be used to build a testing framework to test the quality of an automated machine learning system (e.g., the automated model and pipeline generation tools described herein) in a rigorous and systematic way. For example, each time the automated machine learning system is changed or altered, its performance can be measured against the datasets included in the database. For example, the performance of respective models automatically generated by the automated system can be measured against some portion (e.g., all) of the different tasks or domains. That is, a new version of an automated machine learning system can be used to generate one or more new machine learning models for one or more datasets/tasks/domains included in the database. The performance of these models can be compared to the performance of other models generated by past versions of the system or other systems. The performance of the new models versus the previous models can be used as a proxy for measuring an improvement in or otherwise understanding the performance of the automated machine learning system.

In such fashion, the benchmarking tools described herein can provide for consistent and comparable performance benchmarking not only for specific models, but also for a larger system that seeks to automate aspects of the machine learning process (e.g., architecture searches, etc.). Furthermore, because the database can include data for many different tasks or domains, the performance of the automated machine learning system can be measured and optimized across such different tasks or domains or subsets thereof (e.g., user-defined subsets).

Another example aspect of the present disclosure is directed to a meta-learning system for automated machine learning systems that iteratively improves the automated machine learning systems (e.g., the automated model and pipeline generation tools described herein). More particularly, many automated machine learning systems can themselves be considered to be meta-learning systems in which the automated machine learning system is an “outer loop” that iteratively changes various aspects (e.g., architecture, hyperparameters, etc.) of the model training or generation process (i.e., the “inner loop”) to optimize the model training or generation process, which in turn optimizes the final outputted model. The meta-learning system described herein can be yet another “outer loop” around the automated machine learning system. For example, as described in the paragraphs above, a benchmarking system can store hundreds or thousands of machine learning datasets for different tasks or domains. The meta-learning system for automated machine learning systems can track metadata for every task such that the meta-learning system can apply the principles of iterative testing, learning, and improvement on the automated machine learning systems.

Thus, the parameters or hyperparameters (e.g., system settings such as, for example, number of training iterations) of an automated machine learning system can be tuned (e.g., automatically tuned according to learning-based or black box optimization approaches) over time to continuously improve performance of the automated machine learning system and/or to enable high quality initial performance for new datasets. As one example, the meta-learning system for automated machine learning systems can predict system settings for the automated machine learning system to be applied to a new dataset based on characteristics of the new dataset. For example, statistical measures for the new dataset can be evaluated. Prior datasets that have similar statistical measures can be identified. The system settings that resulted in best performance for such prior datasets can be used as the initial settings for application of the automated machine learning system to the new dataset. For example, the system settings that resulted in best performance for such prior datasets can be averaged (e.g., a weighted average).

In a further example, the meta-learning system for automated machine learning systems can include a machine-learned model (e.g., a neural network) that is trained to predict parameter or hyperparameter (e.g., system settings) for the automated machine learning system to be applied with respect to generation of a model for a new dataset. For example, the new dataset can be provided as input to the machine-learned model and, in one example, the machine-learned model can directly predict the hyperparameter values. In another example, the machine-learned model can generate a dataset embedding for the new dataset within an embedding space that encodes latent information about datasets. In such example, other previous datasets that have embeddings that are similar (e.g., close in distance measure) to the embedding generated for the new dataset can be identified. The system settings that resulted in best performance for such prior datasets can be used as the initial settings for application of the automated machine learning system to the new dataset. For example, the system settings that resulted in best performance for such prior datasets can be averaged (e.g., a weighted average).

In further examples, an ensemble of neural networks can be trained on a dataset of previously trained model hyper-parameters from all “related” prior searches. For example, each neural network in the ensemble can take as input a collection of tuples (e.g., model hyper-parameters, dataset properties), and output (predicted mean, predicted standard deviation) of the objective value. For example, each network can be trained to maximize the log likelihood of the true objective values of all trained models across all prior searches. In some implementations, each neural network can be trained separately from an independently sampled random initialization. At prediction time, the predictions of the neural networks can be ensembled to a single prediction. More precisely, in some examples, the ensemble distribution is a uniform mixture of Gaussian distributions, each of which is produced by a neural network. One example formula (via Bayesian model averaging) is: ensemble mean=mean of predicted means; ensemble standard deviation=mean of (predicted mean \hat{ }2+predicted standard deviation \hat{ }2)−ensemble mean \hat{ }2. The more disagreement there is among the ensemble members, the higher ensemble standard deviation will be, as desired.

Another example aspect of the present disclosure is directed to a tool (e.g., which may be included in the automated model and pipeline generation tools described herein) that performs automated feature engineering to generate a clean set of feature data from raw training data (e.g., raw training data supplied by the user). In particular, a user may supply a set of raw training data that includes only values for a number of features but does not specify a feature type or other metadata or structural data for the features. The automated feature engineering tool described herein can perform automatic semantic type detection for each feature included in the inputted data.

As examples, the automated feature engineering tool can use logic or heuristics to evaluate each feature and output a detected semantic type. Example semantic types include text, image, numerical, etc. As one example, if the feature values contain values that are contained within a color range and demonstrate a repeating structure common to imagery, then the tool can detect that the semantic type is imagery. In another example, if the features values contain only numerical numbers that do not demonstrate a repeating structure common to imagery, then the tool can detect that the semantic type is numerical. Likewise, if the features values contain only textual information, then the tool can detect that the semantic type is textual. The automated feature engineering tool can automatically label the features with the detected semantic type.

The automated feature engineering tool can also perform a statistical analysis to generate new features from the raw data. For example, the automated feature engineering tool can perform various statistical measures such as adjusted mutual information to understand correlations between different features that may enable the generation of additional feature data reflective or demonstrative of such correlations. The automated feature engineering tool can suggest the new features to the user and/or automatically generate and populate the new feature data.

In another example, new features can be automatically or manually generated by searching over large sets of data crosses to find correlations between feature crosses and labels. The automated feature engineering tool can suggest the new features to the user and/or automatically generate and populate the new feature data. For example, the system can provide a user interface by which a user can explore different feature crosses and their respective correlations to different labels, enabling the user to unlock additional levels of data insight, understanding, and interpretability. In addition, users can be enabled to use a relational database (e.g., paired with a structured query language) to create custom features on the fly.

In another aspect, the automated feature engineering tool can assist in selecting a number of seed or initial models or model types based on the feature data. In one example, a list of constraints can be identified, where the constraints indicate types (e.g., semantic types) of feature data that the resulting model should be able or optimized to process. As one example, constraints can be specified by the user. Additionally, or alternatively, the constraints can correspond to or be derived from the semantic types that were automatically detected by the automated feature engineering tool.

The automated feature engineering tool can use the constraints to select a number of seed or initial models or model types (e.g., from a list of candidate models or model types). For example, the automated feature engineering tool can use logic (e.g., encoded in a look up table) to identify models or model types that satisfy the constraints. As one example, if the semantic type of a feature is imagery, then the automated feature engineering tool may limit the seed or initial models to convolutional neural networks, vision transformers, or other models or model types that are known to provide superior performance relative to imagery.

With reference now to the Figures, example implementations of the present disclosure will be discussed in greater detail.

### Example Origination Machine Learning Pipeline

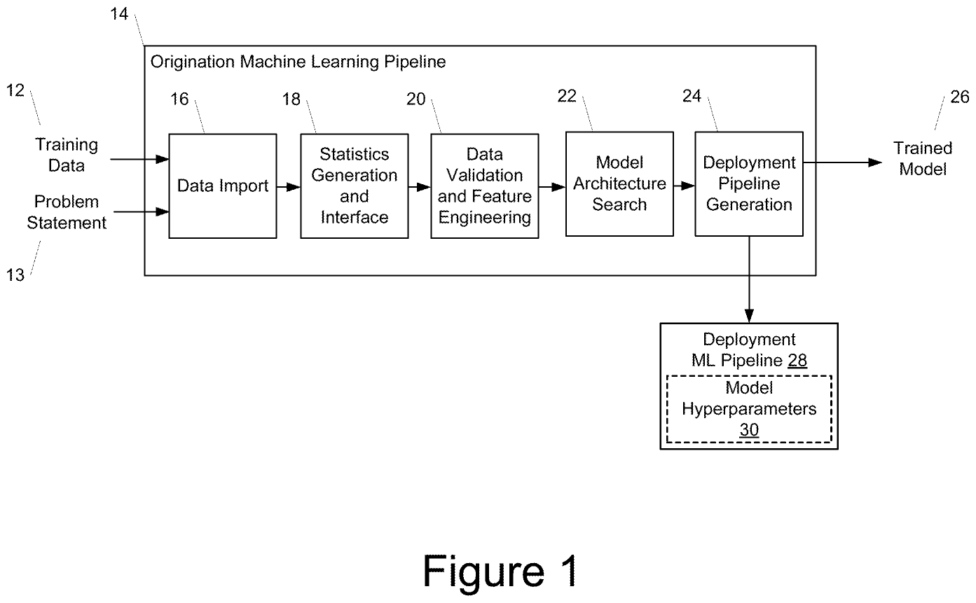

FIG. 1 depicts an example origination ML pipeline 14. The example origination ML pipeline 14 illustrated in FIG. 1 can be configured to receive training data 12 and, optionally, a problem statement 13 from a user. Execution of origination ML pipeline 14 can result in generation and exportation of a trained model 26 and a deployment ML pipeline 28 that is configured to enable deployment of the trained model 26. In at least one implementation, execution of origination ML pipeline 14 can result in generation and exportation of trained model 26, deployment ML pipeline 28, and/or model hyperparameters 30 that can correspond to and/or constitute a subset of hyperparameters of deployment ML pipeline 28 and/or trained model 26. In one or more implementations, origination ML pipeline 14 and deployment ML pipeline 28 can each include computer-readable code that automates the workflow it takes to produce and/or run trained model 26.

More particularly, a user can refer to any individual, organization, or computing system operating on behalf of an individual or organization. Example users of the proposed systems can include engineers, analysts, product managers, researchers, platform developers, etc. Users can interact with the proposed system via a dedicated user interface and/or via an API with defined API calls for certain services. In some implementations, a user can interact with origination ML pipeline 14 via a graphical user interface (GUI) and/or via a programmatic API. For example, in one implementation, an ML platform that provides ML services for various users can request and receive trained model 26, deployment ML pipeline 28 (e.g., including model hyperparameters 30), and/or any of the pipeline generation services described herein from origination ML pipeline 14 via a programmatic API. In this example implementation, origination ML pipeline 14 can receive (e.g., import) training data 12 and, optionally, problem statement 13 from such an ML platform user via the programmatic API, where training data 12 can be associated with the ML platform user and/or one or more individual users associated with the ML platform user. In this example implementation, origination ML pipeline 14 can further export trained model 26 and/or deployment ML pipeline 28 (e.g., including model hyperparameters 30) to such an ML platform user via the programmatic API, where origination ML pipeline 14 can export trained model 26 and/or deployment ML pipeline 28 (e.g., including model hyperparameters 30) for deployment of trained model 26 with (e.g., using) deployment ML pipeline 28.

In one example user journey, a user can supply a set of training data 12 (e.g., which may be structured as data for each of a number of features for each of a number of examples). For instance, training data 12 can include and/or constitute a structured training dataset having data associated with a number of labels. The user can select one of the features as a label (e.g., the feature to be predicted by trained model 26), which may start the search for the best machine learning model. In some implementations, the user may also specify other “advanced” settings from the UI, such as: excluding features, changing feature types, details of the ML task (e.g., corresponding to a problem statement), and details of the search constraints (e.g., corresponding to parameters of an optimization domain associated with a model architecture search). As referenced herein, an “optimization domain” can refer to a list of parameters, their domain (e.g., valid values), and the relationship between them (e.g., one parameter may be conditioned on another one) for an underlying parameterized model.

In some implementations, origination ML pipeline 14 described with reference to FIG. 1 can include and/or otherwise be associated with one or more components that can perform one or more operations associated with data import 16, statistics generation and interface 18, data validation and feature engineering 20, and/or model architecture search 22. In one or more implementations of the present disclosure, such one or more components that can be included in and/or otherwise associated with origination ML pipeline 14 can leverage one or more capabilities of one or more libraries that can be accessed by and/or can provide the base functionality of such one or more components as described below.

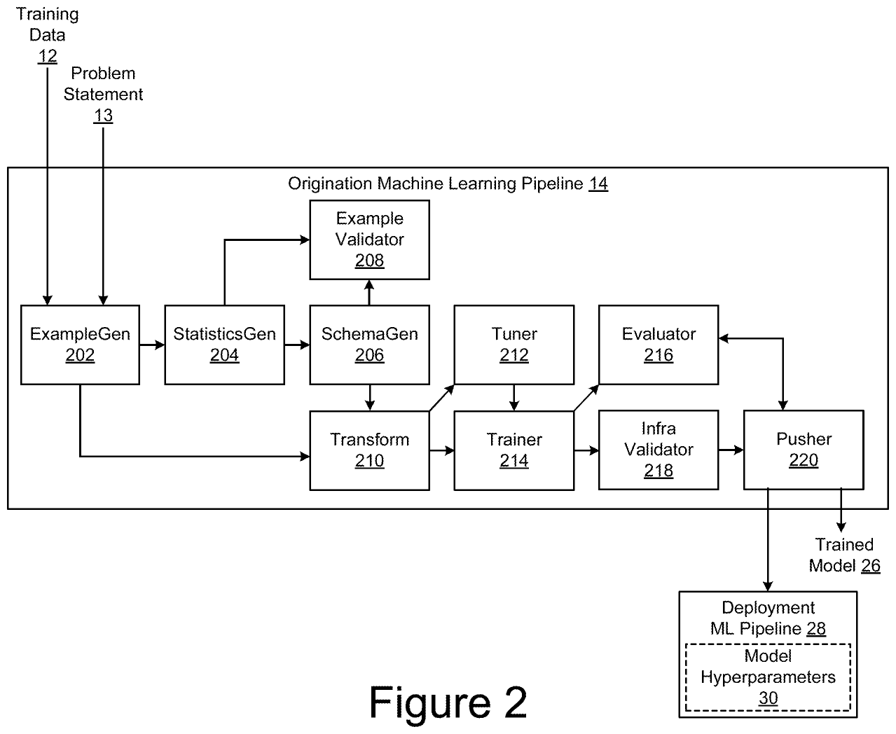

FIG. 2 depicts an example, non-limiting alternative implementation of origination ML pipeline 14. The example origination ML pipeline 14 illustrated in FIG. 2 can be configured to receive training data 12 and, optionally, problem statement 13 from a user (e.g., via a GUI, an API, a REST API, a programmatic API, etc.). Execution of origination ML pipeline 14 illustrated in FIG. 2 can result in generation and exportation of trained model 26 (e.g., exportation via a GUI, an API, a REST API, a programmatic API, etc.). In at least one implementation, execution of origination ML pipeline 14 illustrated in FIG. 2 can result in generation and exportation (e.g., via a GUI, an API, a REST API, a programmatic API, etc.) of trained model 26 and/or deployment ML pipeline 28 (e.g., including model hyperparameters 30). The example origination ML pipeline 14 and deployment ML pipeline 28 depicted in FIG. 2 can each include computer-readable code that automates the workflow it takes to produce and/or run trained model 26 (e.g., to define, launch, and/or monitor trained model 26).

As illustrated in the example implementation depicted in FIG. 2, origination ML pipeline 14 can include an ExampleGen component 202, a StatisticsGen component 204, a SchemaGen component 206, an Example Validator component 208, a Transform component 210, a Tuner component 212, a Trainer component 214, an Evaluator component 216, an Infra Validator component 218, and/or a Pusher component 220. The example implementation depicted in FIG. 2 illustrates how data can flow between such components of origination ML pipeline 14.

In the example implementation depicted in FIG. 2, ExampleGen component 202 can be configured to receive and format training data 12 and, optionally, problem statement 13 to a format compatible to facilitate one or more operations of one or more components of origination ML pipeline 14. In some implementations, ExampleGen component 202 can be configured to perform such formatting after it splits training data 12 into training and evaluation datasets, which results in two copies of ExampleGen component 202, one each for training and evaluation.

In the example implementation depicted in FIG. 2, StatisticsGen component 204 can be configured to receive the formatted training data 12 from ExampleGen component 202. In this implementation, StatisticsGen component 204 can be configured to examine the formatted training data 12 and infer (e.g., calculate) one or more statistics corresponding to such formatted training data 12. In this way, StatisticsGen component 204 can be configured to generate one or more statistics descriptive of training data 12.

In some implementations, the StatisticsGen component 204 can also perform a statistical analysis to generate new features from the raw data. For example, the StatisticsGen component 204 can perform various statistical measures such as adjusted mutual information to understand correlations between different features that may enable the generation of additional feature data reflective or demonstrative of such correlations. The StatisticsGen component 204 can suggest the new features to the user and/or automatically generate and populate the new feature data.

In another example, new features can be automatically or manually generated by searching over large sets of data crosses to find correlations between feature crosses and labels. The StatisticsGen component 204 or Transform component 210 discussed below can suggest the new features to the user and/or automatically generate and populate the new feature data. For example, the StatisticsGen component 204 or Transform component 210 discussed below can provide a user interface by which a user can explore different feature crosses and their respective correlations to different labels, enabling the user to unlock additional levels of data insight, understanding, and interpretability. In addition, users can be enabled to use a relational database (e.g., paired with a structured query language) to create custom features on the fly.

In one or more implementations, origination ML pipeline 14 and/or StatisticsGen component 204 can be configured to store metadata descriptive of such one or more statistics in a library and/or a memory device that can be accessed by origination ML pipeline 14 and/or one or more components thereof to retrieve the metadata descriptive of the one or more statistics. For example, origination ML pipeline 14 and/or StatisticsGen component 204 can be configured to store metadata descriptive of such one or more statistics in a machine learning (ML) metadata library and/or a memory device that can be accessed by origination ML pipeline 14 and/or one or more components thereof to retrieve the metadata descriptive of the one or more statistics.

In the example implementation depicted in FIG. 2, SchemaGen component 206 can be configured to receive the formatted training data 12 and/or the above-described statistics corresponding to such formatted training data 12 from StatisticsGen component 204. In this implementation, SchemaGen component 206 can be configured to examine such statistics and infer a data schema corresponding to the formatted training data 12. As referenced herein, “schema” can refer to a description of training data 12 that can be used by one or more components of origination ML pipeline 14. In some implementations, a schema as defined herein can include and/or constitute an instance and/or a type of a protocol buffer (also referred to as a “protobuf”). In some implementations, the schema can specify, for instance: data type(s) for feature value(s); whether a feature is to be present in all examples; allowed value ranges; and/or another property of training data 12.

In some implementations, the SchemaGen component 206 can be configured to use logic or heuristics to evaluate each feature and output a detected semantic type. Example semantic types include text, image, numerical, etc. As one example, if the feature values contain values that are contained within a color range and demonstrate a repeating structure common to imagery, then the tool can detect that the semantic type is imagery. In another example, if the features values contain only numerical numbers that do not demonstrate a repeating structure common to imagery, then the tool can detect that the semantic type is numerical. Likewise, if the features values contain only textual information, then the tool can detect that the semantic type is textual. The SchemaGen component 206 can automatically label the features with the detected semantic type.

In one or more implementations, origination ML pipeline 14 and/or SchemaGen component 206 can be configured to store metadata descriptive of such a data schema in a library and/or a memory device that can be accessed by origination ML pipeline 14 and/or one or more components thereof to retrieve the metadata descriptive of the data schema. For example, origination ML pipeline 14 and/or SchemaGen component 206 can be configured to store metadata descriptive of such a data schema in an ML metadata library and/or a memory device that can be accessed by origination ML pipeline 14 and/or one or more components thereof to retrieve the metadata descriptive of the data schema.

In the example implementation depicted in FIG. 2, Example Validator component 208 can be configured to receive the above-described statistics and data schema from StatisticsGen component 204 and SchemaGen component 206, respectively. In this implementation, Example Validator component 208 can be configured to examine such statistics and data schema to identify any anomalies, missing values, and/or incorrect data types in the formatted training data 12.

In some implementations, to perform one or more of the above-described operations, ExampleGen component 202, StatisticsGen component 204, SchemaGen component 206, and/or Example Validator component 208 can be configured to leverage one or more capabilities of one or more libraries that can be accessed by and/or can provide the base functionality of such component(s) of origination ML pipeline 14. For example, in these implementations, such component(s) of origination ML pipeline 14 can be configured to leverage one or more libraries written in the Python programming language that provide the base functionality of such component(s). For instance, in one or more implementations, ExampleGen component 202, StatisticsGen component 204, SchemaGen component 206, and/or Example Validator component 208 can be configured to leverage one or more capabilities of a validation library (e.g., a tensorflow validation library). In these one or more implementations, such component(s) of origination ML pipeline 14 can be configured to leverage one or more capabilities of such a validation library to, for instance, perform initial exploration, visualization, and/or cleaning of training data 12. In these one or more implementations, such component(s) of origination ML pipeline 14 can be configured to leverage one or more capabilities of such a validation library to, for instance: examine training data 12 and infer the data types, categories, and/or ranges in training data 12 (e.g., via StatisticsGen component 204 and/or SchemaGen component 206); and/or identify anomalies, missing values, and/or incorrect data types in training data 12 (e.g., via Example Validator component 208).

In some implementations, ExampleGen component 202, StatisticsGen component 204, SchemaGen component 206, and/or Example Validator component 208 can be configured to leverage one or more capabilities of the above-described validation library and/or one or more visualization tools thereof to enable origination ML pipeline 14 and/or a user to examine and understand training data 12 (e.g., via metadata corresponding to training data 12). In some implementations, origination ML pipeline 14 and/or the user can query a machine learning metadata library to locate results of the executions of ExampleGen component 202, StatisticsGen component 204, SchemaGen component 206, and/or Example Validator component 208 and then use such one or more visualization tools (e.g., a visualization support API) of the validation library to create and/or view (e.g., via a monitor of a computing device associated with the user) such results of the executions (e.g., the above-described statistics, schema, etc.). In these implementations, after multiple executions of ExampleGen component 202, StatisticsGen component 204, SchemaGen component 206, and/or Example Validator component 208, origination ML pipeline 14 and/or the user can employ such one or more visualization tools to compare results corresponding to each of such multiple executions and then make adjustments as needed until origination ML pipeline 14 and/or the user is satisfied that training data 12 is in a desirable state to train a model such that it operates according to a certain application that can be defined by the user (e.g., via problem statement 13).

In at least one implementation, the above-described validation library can include and/or constitute a scalable library that can facilitate analyzing and/or validating machine learning data. In this implementation, such a validation library can facilitate operations that can include, but are not limited to: scalable calculation of summary statistics of training and test data; integration with a viewer for data distributions and statistics and/or faceted comparison of pairs of datasets; automated data-schema generation to describe expectations about data such as, for example, required values, ranges, and/or vocabularies; inspection of the schema via, for instance, a schema viewer; anomaly detection to identify anomalies such as, for example, missing features, out-of-range values, and/or wrong feature types; inspection of such anomalies via, for instance, an anomalies viewer to enable a user to see what features have anomalies and learn more in order to correct them; and/or another operation.

In some implementations, after an initial model training and deployment (e.g., training and deployment of trained model 26), ExampleGen component 202, StatisticsGen component 204, SchemaGen component 206, and/or Example Validator component 208 can each be configured to leverage one or more capabilities of the above-described validation library to, for instance: monitor new data from inference requests submitted to trained model 26 after it has been deployed by origination ML pipeline 14 as described below; and/or identify anomalies and/or drift. In these implementations, such operations are beneficial when applied to time series data that changes over time as a result of a trend or seasonality and can further help inform a user when there are data problems or when trained model 26 needs to be retrained on new data. In these implementations, another benefit of such a validation library is that it can be used (e.g., by SchemaGen component 206) to generate a schema by inferring data types, categories, and/or ranges from training data 12.

In the example implementation depicted in FIG. 2, Transform component 210 can be configured to perform feature engineering on training data 12. For example, in at least one implementation, Transform component 210 can be configured to receive the above-described formatted and/or split training data 12, statistics, and schema and apply data transformations to create, combine, and/or transform the features that will be used to train a candidate ML model (e.g., a certain ML architecture that can be instantiated, trained, and/or evaluated as described herein in accordance with one or more implementations). In this at least one implementation, Transform component 210 can be configured to further cleanup missing values and/or convert data types corresponding to training data 12. For instance, Transform component 210 can be configured to cleanup missing values and/or convert data types corresponding to training data 12 in implementations where there is a possibility that these will also be present in data sent for inference requests (e.g., to trained model 26).

In some implementations, to perform the above-described feature engineering operations, Transform component 210 can be configured to leverage one or more capabilities of one or more libraries that can be accessed by and/or can provide the base functionality of Transform component 210. For example, in these implementations, Transform component 210 can be configured to leverage one or more capabilities of one or more libraries written in the Python programming language that provide the base functionality of Transform component 210. For instance, in one or more implementations, Transform component 210 can be configured to leverage one or more capabilities of a transform library that can facilitate preprocessing of training data 12. By way of example, in these one or more implementations, Transform component 210 can be configured to leverage one or more capabilities of such a transform library to perform preprocessing operations on training data 12 that can include, but are not limited to: normalizing an input value by mean and standard deviation; converting strings to integers by generating a vocabulary over all input values; converting floats to integers by assigning them to buckets based on the observed data distribution; and/or another operation.

In some implementations, the output of Transform component 210 can include and/or constitute a serialization of a model that can be referred to herein as a “SavedModel” and can include all the data engineering transformations that were created by Transform component 210. As referenced herein, a “SavedModel” can refer to a universal, language-neutral, hermetic, recoverable serialization of a model. For example, a SavedModel as referenced herein can include and/or constitute the recommended serialization format that can be used by origination ML pipeline 14 and/or one or more components thereof to serve a model in production or export a trained model for a certain computing device (e.g., a smart phone, tablet, etc.) and/or a certain software application (e.g., a software application written in a certain language). For instance, to facilitate conversion of a model into a representational state transfer (REST) service to make predictions, origination ML pipeline 14 can serialize a model as a SavedModel and serve it (e.g., using one or more capabilities of a serving library). In the above examples, a benefit of such a SavedModel is that it enables higher-level systems to produce, transform, and/or consume models using a single abstraction. Additionally, and/or alternatively, a “model” as referenced herein can refer to the output of a training process. For example, a model as referenced herein can include and/or constitute the serialized record of weights that have been learned during the training process and/or weights that have been learned up to a certain point in the training process. In some implementations of the present disclosure, such weights can be subsequently used to compute predictions for new input examples.

In some implementations described herein, Tuner component 212 can be configured to search an optimization domain as defined herein to identify a candidate ML model (hereinafter, “candidate model”) having a certain ML model architecture (e.g., certain parameters, hyperparameters, model hyperparameters 30, etc.) that can satisfy an objective of a user (e.g., an objective defined in problem statement 13). In these implementations, such a search of the optimization domain can constitute an ML model architecture search that can be performed by Tuner component 212 to identify one or more candidate models that can be instantiated, trained, evaluated, and/or deployed as described herein in accordance with one or more implementations of the present disclosure.

In some implementations, to perform the above-described ML model architecture search to identify a candidate model, Tuner component 212 can be configured to select a number of seed or initial models or model types based on the feature data. In one example, a list of constraints can be identified, where the constraints indicate types (e.g., semantic types) of feature data that the resulting model should be able or optimized to process. As one example, constraints can be specified by the user. Additionally, or alternatively, the constraints can correspond to or be derived from the semantic types that were automatically detected by the SchemaGen component 206.

The Tuner component 212 can use the constraints to select a number of seed or initial models or model types (e.g., from a list of candidate models or model types). For example, the Tuner component 212 can use logic (e.g., encoded in a look up table) to identify models or model types that satisfy the constraints. As one example, if the semantic type of a feature is imagery, then the Tuner component 212 may limit the seed or initial models to convolutional neural networks, vision transformers, or other models or model types that are known to provide superior performance relative to imagery.

In some implementations, to perform the above-described ML model architecture search to identify a candidate model, Tuner component 212 can be configured to employ an algorithm that can search the optimization domain to identify the relatively best ML model architecture (e.g., parameters, hyperparameters, model hyperparameters 30, etc.) based on a certain objective (e.g., an objective that can be defined by a user in problem statement 13). For instance, Tuner component 212 can be configured to employ a search algorithm, a tuner algorithm, a Gaussian algorithm and/or process, a neural architecture search (NAS) algorithm, a reinforcement learning (RL) algorithm, and/or another algorithm to identify the relatively best ML model architecture (e.g., parameters, hyperparameters, model hyperparameters 30, etc.) based on a certain objective (e.g., an objective that can be defined by a user in problem statement 13). In some implementations, to perform the ML model architecture search and/or identify the one or more candidate models, Tuner component 212 can be configured to leverage one or more capabilities of one or more libraries that can be accessed by and/or can provide the functionality of Tuner component 212. For example, in these implementations, Tuner component 212 can be configured to leverage one or more capabilities of one or more libraries written in the Python programming language that can enable Tuner component 212 to perform the ML model architecture search and/or identify the one or more candidate models.

In some implementations, Tuner component 212 can be configured to perform the above-described ML model architecture search based at least in part on training data 12, problem statement 13, and/or one or more attributes corresponding to training data 12 and/or problem statement 13. For instance, in an example implementation, Tuner component 212 can be configured to perform the ML model architecture search based at least in part on metadata descriptive of training data 12, problem statement 13, and/or one or more attributes corresponding to training data 12 and/or problem statement 13. For example, Tuner component 212 can be configured to perform the ML model architecture search based at least in part on the above-described metadata descriptive of the statistics and/or schema that can be stored in, for instance, an ML metadata library by StatisticsGen component 204 and SchemaGen component 206, respectively.

In another example implementation, Tuner component 212 can be configured to infer, based on problem statement 13, one or more parameters of the optimization domain to identify such a candidate model having a certain ML model architecture (e.g., certain parameters, hyperparameter, model hyperparameters 30, etc.). In another example implementation, Tuner component 212 and/or one or more other components of origination ML pipeline 14 (e.g., ExampleGen component 202, StatisticsGen component 204, SchemaGen component 206, Example Validator component 208, and/or Transform component 210) can be configured to detect a semantic type for one or more features of a plurality of features included in training data 12. In this example implementation, Tuner component 212 can be configured to perform the above-described ML model architecture search based at least in part on such detected semantic type for one or more features of a plurality of features included in training data 12. For instance, in this example implementation, Tuner component 212 can be configured to constrain the ML model architecture search to candidate model architectures capable of processing the semantic type detected for the one or more features of the plurality of features included in training data 12.

In some implementations, the output of Tuner component 212 can include and/or constitute one or more parameters and/or hyperparameters (e.g., values of one or more parameters and/or hyperparameter) of a candidate model that can be identified by Tuner component 212 when searching an optimization domain as described above. For example, in some implementations, the output of Tuner component 212 can include and/or constitute model hyperparameters 30 (e.g., values of model hyperparameters 30), which can constitute hyperparameters of a candidate model that can be identified by Tuner component 212 when searching an optimization domain as described above. In these or other implementations, origination ML pipeline 14 and/or Tuner component 212 can be configured to store such one or more parameters and/or hyperparameters (e.g., to store model hyperparameters 30). In one or more implementations, origination ML pipeline 14 and/or Tuner component 212 can be configured to store metadata descriptive of such one or more parameters and/or hyperparameters (e.g., model hyperparameters 30) in a library and/or a memory device that can be accessed by origination ML pipeline 14 and/or one or more components thereof to retrieve the metadata descriptive of the one or more parameters and/or hyperparameters. For example, in one implementation, origination ML pipeline 14 and/or Tuner component 212 can be configured to store metadata descriptive of such one or more parameters and/or hyperparameters (e.g., model hyperparameters 30) in a library an ML metadata library and/or a memory device that can be accessed by origination ML pipeline 14 and/or one or more components thereof to retrieve the metadata descriptive of the one or more parameters and/or hyperparameters. In this implementation, storing such metadata descriptive of the one or more parameters and/or hyperparameters (e.g., model hyperparameters 30) in such a library and/or a memory device can constitute storing metadata descriptive of the performance (e.g., results) of the above-described ML model architecture search of the optimization domain that can be performed by Tuner component 212.

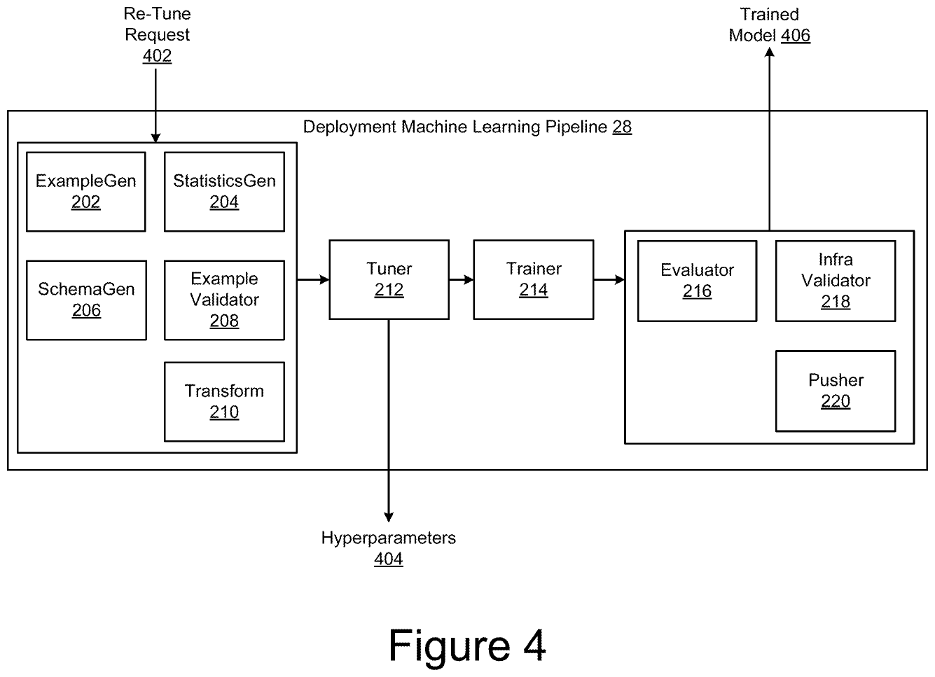

In some implementations of the present disclosure, Tuner component 212 can be configured to tune one or more parameters and/or hyperparameters of a candidate model. In some implementations (e.g., as described below with reference to FIG. 4), Tuner component 212 can be configured to re-tune one or more parameters and/or hyperparameters of a previously trained model (e.g., trained model 26). For example, in some implementations, Tuner component 212 can be configured to tune one or more parameters and/or hyperparameters such as, for instance, number of layers of the candidate model and/or another parameter and/or hyperparameter. In an example implementation, Tuner component 212 can be configured to tune one or more parameters and/or hyperparameters of a candidate model based on (e.g., using and/or according to) the stored metadata descriptive of training data 12 and the performance (e.g., results) of the above-described ML model architecture search that can be performed by Tuner component 212. In this example implementation, such tuning of one or more parameters and/or hyperparameters of a candidate model based on the stored metadata descriptive of training data 12 and the performance (e.g., results) of the above-described ML model architecture search can constitute tuning of one or more parameters and/or hyperparameters of and/or associated with origination ML pipeline 14 based on such stored metadata.

In these implementations, to tune one or more parameters and/or hyperparameters of a candidate model, Tuner component 212 can be configured to employ an algorithm that can search the above-described optimization domain to identify the relatively best parameters and/or hyperparameters for the candidate model based on a certain objective (e.g., an objective that can be defined by a user in problem statement 13). For instance, Tuner component 212 can be configured to employ a search algorithm, a tuner algorithm, a Gaussian algorithm and/or process, a neural architecture search (NAS) algorithm, a reinforcement learning (RL) algorithm, and/or another algorithm to identify the relatively best parameters and/or hyperparameters for the candidate model. In some implementations, to tune one or more parameters and/or hyperparameters of a candidate model, Tuner component 212 can be configured to leverage one or more capabilities of one or more libraries that can be accessed by and/or can provide the functionality of Tuner component 212. For example, in these implementations, Tuner component 212 can be configured to leverage one or more capabilities of one or more libraries written in the Python programming language that can enable Tuner component 212 to tune such one or more parameters and/or hyperparameters of the candidate model.

In the example implementation depicted in FIG. 2, Trainer component 214 can be configured to train a candidate model. For example, in some implementations, Trainer component 214 can be configured to receive the above-described SavedModel, candidate model, and/or one or more parameters and/or hyperparameters of the candidate model from Transform component 210 and/or Tuner component 212. In these implementations, the SavedModel and/or candidate model can include all the data engineering transformations that were created by Transform component 210 such that the identical transforms can be performed using the exact same computer-readable code during both training and inference (e.g., the above-described computer-readable code that can be included in and/or used by origination ML pipeline 14 to automate the workflow it takes to produce and/or run trained model 26). In these implementations, by using such exact same computer-readable code (also referred to herein as “modeling code”), including the SavedModel and/or candidate model, Trainer component 214 can consume training data 12 (e.g., training data 12 that has been split into training and evaluation data) and train the candidate model.

In some implementations, to train a candidate model, Trainer component 214 can be configured to leverage one or more capabilities of one or more libraries that can be accessed by and/or can provide the base functionality of Trainer component 214. For example, in these implementations, Trainer component 214 can be configured to leverage one or more capabilities of one or more libraries written in the Python programming language that provide the base functionality of Trainer component 214. For instance, in one or more implementations, Trainer component 214 can be configured to leverage one or more capabilities of a library (e.g., a tensorflow library) that ingests training data and modeling code and creates a SavedModel result. In these one or more implementations, such a library can also integrate a feature engineering pipeline that can be created by Transform component 210 to preprocess input data (e.g., training data 12).

In implementations involving an Estimator based model, Trainer component 214 can be configured to save a trained candidate model as both a SavedModel and an “EvalSavedModel” that becomes the basis for the analysis performed by Evaluator component 216 as described below. In these implementations, saving such a trained candidate model as an EvalSavedModel ensures the metrics used at training time are also available during evaluation by Evaluator component 216. In these implementations, to facilitate saving the trained candidate model as an EvalSavedModel, Trainer component 214 can be configured to leverage one or more capabilities of a library that can be accessed by and/or can provide the functionality of Trainer component 214. For example, in these implementations, Trainer component 214 can be configured to leverage one or more capabilities of a model analysis library described below with reference to Evaluator component 216.

In the example implementation depicted in FIG. 2, Evaluator component 216 can be configured to perform a deep analysis of training results from training a candidate model (e.g., via Trainer component 214) and to facilitate validation of such a candidate model to ensure it is satisfactory to be pushed to production. In some implementations, following initial model development and training as described above, Evaluator component 216 can be configured to analyze the model's performance. For example, in these implementations, Evaluator component 216 can be configured to receive a trained model (e.g., as a SavedModel) and analyze the model's performance based on a slice of training data 12 (e.g., a list of data items, features, labels, etc. of training data 12). For instance, in these implementations, Evaluator component 216 can be configured to analyze the model's performance against a slice of training data 12 including one or more particular categories for categorical features, one or more particular ranges for numerical features, and/or another slice of training data 12.

In the above implementations, such analysis of the performance of a trained candidate model against such a slice of training data 12 can be beneficial in understanding the model's performance with respect to, for instance, different segments of entities (e.g., customers) associated with origination ML pipeline 14 and/or the outputs thereof (e.g., trained model 26 and/or deployment ML pipeline 28). In these implementations, Evaluator component 216 can be configured to segment the entities by, for instance, annual purchases, geographical data, age group, gender, and/or another attribute. In these implementations, such analysis by Evaluator component 216 can be especially beneficial for datasets with long tails, where the performance of the trained candidate model with respect to a dominant group may mask unacceptable performance of the model with respect to one or more smaller groups. For example, Evaluator component 216 can determine that the trained candidate model can perform relatively well for average employees but performs relatively poorly for executive staff, and this information may be useful to a user implementing origination ML pipeline 14.

In some implementations, to evaluate the performance of a trained candidate model, Evaluator component 216 can be configured to leverage one or more capabilities of one or more libraries that can be accessed by and/or can provide the base functionality of Evaluator component 216. For example, in these implementations, Evaluator component 216 can be configured to leverage one or more capabilities of one or more libraries written in the Python programming language that provide the base functionality of Evaluator component 216. For instance, in one or more implementations, Evaluator component 216 can be configured to leverage one or more capabilities of a model analysis library. In these one or more implementations, Evaluator component 216 can be configured to leverage such one or more capabilities of the model analysis library to create an EvalSavedModel that then becomes the basis for the analysis by Evaluator component 216. In these one or more implementations, such a model analysis library can enable Evaluator component 216 to evaluate a trained candidate model on large amounts of data in a distributed manner, using the same metrics defined by Trainer component 214. In some implementations, such metrics can be computed over different slices of training data 12 and/or visualized for viewing by, for instance, a user implementing origination ML pipeline 14.

In some implementations, Evaluator component 216 can be configured to leverage one or more capabilities of the above-described model analysis library and/or one or more visualization tools thereof to enable origination ML pipeline 14 and/or a user to examine and understand results of the model performance analysis that can be performed by Evaluator component 216 as described above. In some implementations, origination ML pipeline 14 and/or the user can query a machine learning metadata library to locate results of the executions of Evaluator component 216 and then use such one or more visualization tools (e.g., a visualization support API) of the model analysis library to create and/or view (e.g., via a monitor of a computing device associated with the user) such results of the executions (e.g., the above-described performance results with respect to one or more slices of training data 12). In these implementations, after multiple executions of Evaluator component 216 (e.g., multiple performance analyses of the trained candidate model against different slices of training data 12), origination ML pipeline 14 and/or the user can employ such one or more visualization tools to compare results corresponding to each of such multiple executions and then make adjustments to the trained candidate model as needed (e.g., via Transform component 210, Trainer component 214, Tuner component 212, etc.) until origination ML pipeline 14 and/or the user is satisfied that the model and/or the results produced by the model can achieve a certain objective and/or application that can be defined by the user (e.g., via problem statement 13).

In some implementations, as part of analyzing the performance of a trained candidate model, Evaluator component 216 can be configured to validate the performance of the model against a baseline such as, for instance, a currently serving model (e.g., a model currently executing on an infrastructure of a computing system). In these implementations, Evaluator component 216 can be configured to receive both a trained candidate model (e.g., as a SavedModel) and a baseline model (e.g., a model currently executing on a computing system infrastructure). In these implementations, Evaluator component 216 can be configured to compute metrics (e.g., area under the curve (AUC), loss, etc.) for both the trained candidate model and the baseline model along with, for instance, a corresponding set of diff metrics. In these implementations, origination ML pipeline 14 and/or Evaluator component 216 can then apply and use one or more thresholds to gate push the trained candidate model and/or one or more other models (e.g., one or more other SavedModels) subsequently generated by origination ML pipeline 14 to production.

In the example implementation depicted in FIG. 2, Infra Validator component 218 can be configured to determine whether a trained candidate model is servable from a certain infrastructure (e.g., an infrastructure of a computing system and/or device associated with origination ML pipeline 14). In one or more implementations, Infra Validator component 218 can be configured to determine whether a trained candidate model is servable in a production environment to ensure that such a model does not prevent the system from serving predictions. In these one or more implementations, to perform such a determination, Infra Validator component 218 can be configured to implement a canary deployment of the trained candidate model in a sandboxed environment (e.g., a deployment of the model in a canary model server), and optionally send real requests to check that the trained candidate model works correctly. In some implementations, if it is determined by Infra Validator component 218 that the trained candidate model is not servable from such a certain infrastructure, Infra Validator component 218 can prevent such a model from being pushed to production.

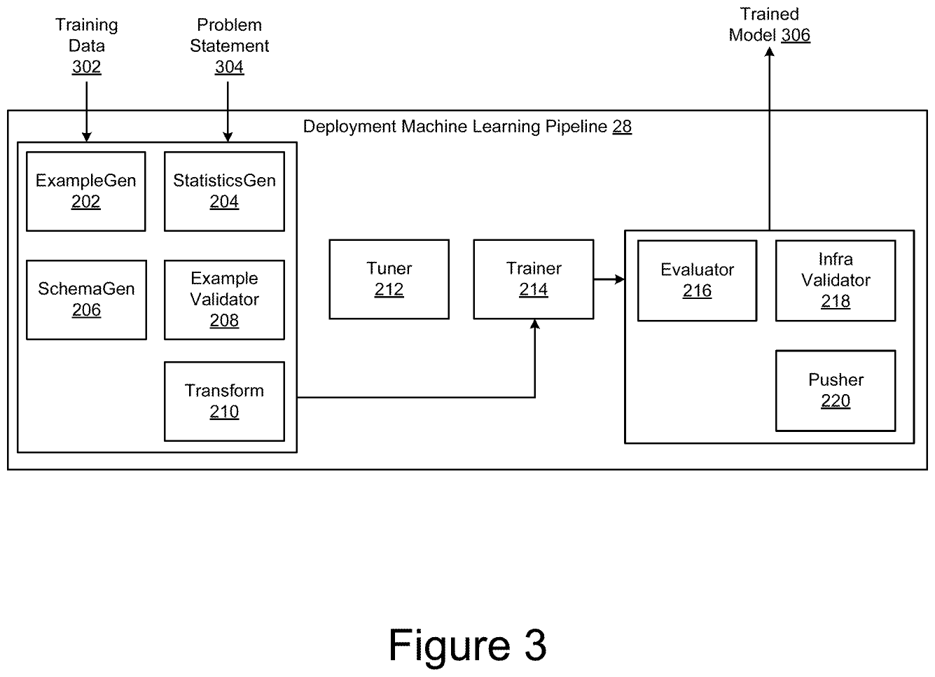

In the example implementation depicted in FIG. 2, Pusher component 220 can be configured to deploy a trained model (e.g., a SavedModel, trained candidate model, trained model 26, etc.) generated by origination ML pipeline 14 onto a serving infrastructure where such a model can receive inference requests. For example, in implementations where Infra Validator component 218 determines that a trained model (e.g., a SavedModel, trained candidate model, trained model 26, etc.) is servable from a certain serving infrastructure, Pusher component 220 can be configured to deploy the model onto the serving infrastructure. In some implementations, such deployment by Pusher component 220 onto such a serving infrastructure can include handling (e.g., deploying, managing, implementing, modifying, etc.) multiple versions of the trained model and/or model updates corresponding to the trained model and/or multiple versions thereof (e.g., via deployment ML pipeline 28 and/or model hyperparameters 30 as described below with reference to FIG. 3).

In some implementations, to deploy such a trained model (e.g., a SavedModel, trained candidate model, trained model 26, etc.) onto a serving infrastructure, Pusher component 220 can be configured to leverage one or more capabilities of a library and/or a system that can serve machine learning models in a production environment. For example, in these implementations, Pusher component 220 can be configured to leverage one or more capabilities of a serving system that can consume a SavedModel and accept inference requests via an interface component (e.g., a REST API). In these implementations, such a service system that can be employed by Pusher component 220 to deploy a trained model onto a service infrastructure can be configured to run as a set of processes on one or more network servers, using one of several advanced architectures to handle synchronization and distributed computation.

### Example Deployment Machine Learning Pipeline

FIG. 3 depicts an example, non-limiting implementation of deployment ML pipeline 28. The example deployment ML pipeline 28 illustrated in FIG. 3 can be configured to receive training data 302 and, optionally, problem statement 304 from a user (e.g., via a GUI, an API, a REST API, a programmatic API, etc.). Execution of deployment ML pipeline 28 illustrated in FIG. 3 can result in generation and exportation of trained model 306 (e.g., exportation via a GUI, an API, a REST API, a programmatic API, etc.). The example deployment ML pipeline 28 depicted in FIG. 3 can include computer-readable code that automates the workflow it takes to produce and/or run trained model 306 (e.g., to define, launch, and/or monitor trained model 306).

As illustrated in the example implementation depicted in FIG. 3, deployment ML pipeline 28 can include ExampleGen component 202, StatisticsGen component 204, SchemaGen component 206, Example Validator component 208, Transform component 210, Tuner component 212, Trainer component 214, Evaluator component 216, Infra Validator component 218, and/or Pusher component 220, which can perform their respective operations in the same manner as described above with reference to FIG. 2. The example implementation depicted in FIG. 3 illustrates how data can flow between such components of deployment ML pipeline 28.

In the example implementation illustrated in FIG. 3, Trainer component 214 can be configured to retrain an ML model. For example, in this implementation, following execution of origination ML pipeline 14 to generate and/or deploy trained model 26 and/or deployment ML pipeline 28 (e.g., including model hyperparameters 30) as described above with reference to FIG. 2, Trainer component 214 can retrain trained model 26 based on (e.g., using) training data 302 and, optionally, problem statement 304. In this implementation, training data 302 can include training data that is different from that of training data 12 and/or problem statement 304 can include a problem definition that is different from that of problem statement 13.

In the example implementation depicted in FIG. 3, ExampleGen component 202, StatisticsGen component 204, SchemaGen component 206, Example Validator component 208, and/or Transform component 210 can be configured to perform their respective operations (e.g., operations described above with reference to FIG. 2) on training data 302 and/or problem statement 304 in the same manner as they performed such operations on training data 12 and/or problem statement 13. In this implementation, based on the respective outputs of such components that can be produced for training data 302 and, optionally, problem statement 304, Trainer component 214 can use such outputs to retrain trained model 26 and thereby produce trained model 306. In some implementations of the present disclosure, Trainer component 214 can be configured to retrain trained model 26 with (e.g., using) a fixed list of feature columns and thereby produce trained model 306. In the example implementation depicted in FIG. 3, Evaluator component 216, Infra Validator component 218, and/or Pusher component 220 can be configured to perform their respective operations (e.g., operations described above with reference to FIG. 2) on trained model 306 such that after a satisfactory evaluation of trained model 306 (e.g., via Evaluator component 216) and a satisfactory evaluation of a target deployment infrastructure (e.g., via Infra Validator 218), Pusher component 220 can deploy trained model 306 to the target deployment infrastructure.

### Example Deployment Machine Learning Pipeline

FIG. 4 depicts an example, non-limiting alternative implementation of deployment ML pipeline 28. The example deployment ML pipeline 28 illustrated in FIG. 4 can be configured to receive a re-tune request 402 from a user (e.g., via a GUI, an API, a REST API, a programmatic API, etc.). In some implementations, re-tune request 402 can include training data 12 and, optionally, problem statement 13 and/or a different (e.g., new) problem statement. Execution of deployment ML pipeline 28 illustrated in FIG. 4 can result in generation and exportation of trained model 406 (e.g., exportation via a GUI, an API, a REST API, a programmatic API, etc.). In at least one implementation, execution of deployment ML pipeline 28 illustrated in FIG. 4 can result in generation and exportation (e.g., via a GUI, an API, a REST API, a programmatic API, etc.) of hyperparameters 404 and/or trained model 406. The example deployment ML pipeline 28 depicted in FIG. 4 can include computer-readable code that automates the workflow it takes to produce and/or run trained model 406 (e.g., to define, launch, and/or monitor trained model 406).

As illustrated in the example implementation depicted in FIG. 4, deployment ML pipeline 28 can include ExampleGen component 202, StatisticsGen component 204, SchemaGen component 206, Example Validator component 208, Transform component 210, Tuner component 212, Trainer component 214, Evaluator component 216, Infra Validator component 218, and/or Pusher component 220, which can perform their respective operations in the same manner as described above with reference to FIG. 2. The example implementation depicted in FIG. 4 illustrates how data can flow between such components of deployment ML pipeline 28.

In the example implementation illustrated in FIG. 4, Tuner component 212 can be configured to perform a second ML model architecture search to identify a new machine learning model (e.g., new parameters and/or hyperparameters such as, for instance, hyperparameters 404) for training data 12. For example, in this implementation, following execution of origination ML pipeline 14 to generate and/or deploy trained model 26 and/or deployment ML pipeline 28 (e.g., including model hyperparameters 30) as described above with reference to FIG. 2, Tuner component 212 can retune trained model 26 based on (e.g., using) training data 12 and, optionally, problem statement 13 and/or a different (e.g., new) problem statement.

In the example implementation depicted in FIG. 4, ExampleGen component 202, StatisticsGen component 204, SchemaGen component 206, Example Validator component 208, and/or Transform component 210 can be configured to perform their respective operations on training data 12, problem statement 13, and/or a different (e.g., new) problem statement in the same manner as they performed such operations in the example implementation described above with reference to FIG. 2. In this implementation, based on the respective outputs of such components that can be produced for training data 12 and, optionally, problem statement 13 and/or a different (e.g., new) problem statement, Tuner component 212 can use such outputs to retune trained model 26 and thereby produce hyperparameters 404 and/or trained model 406. In this implementation, to retune trained model 26, Tuner component 212 can be configured to perform a second (e.g., a new) ML model architecture search of an optimization domain as defined herein (e.g., the above-described optimization domain) to identify a new machine learning model (e.g., new parameters and/or hyperparameters such as, for instance, hyperparameters 404) for training data 12. For example, in this implementation, Tuner component 212 can be configured to perform the second ML model architecture search in the same manner as described above with reference to FIG. 2. In this implementation, based on performing the second ML model architecture search, Tuner component 212 can be configured to output hyperparameters 404 and/or trained model 406 (e.g., as a SavedModel), where trained model 406 can include hyperparameters 404. In the example implementation depicted in FIG. 4, Evaluator component 216, Infra Validator component 218, and/or Pusher component 220 can be configured to perform their respective operations (e.g., operations described above with reference to FIG. 2) on trained model 406 such that after a satisfactory evaluation of trained model 406 (e.g., via Evaluator component 216) and a satisfactory evaluation of a target deployment infrastructure (e.g., via Infra Validator 218), Pusher component 220 can deploy trained model 406 to the target deployment infrastructure.

### Example Devices and Systems

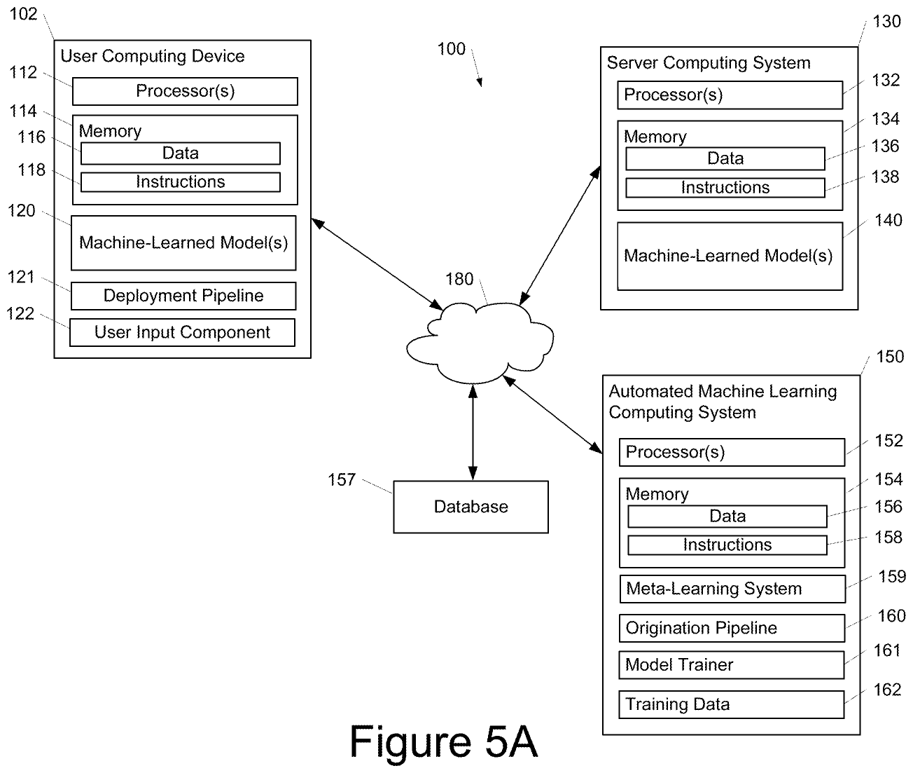

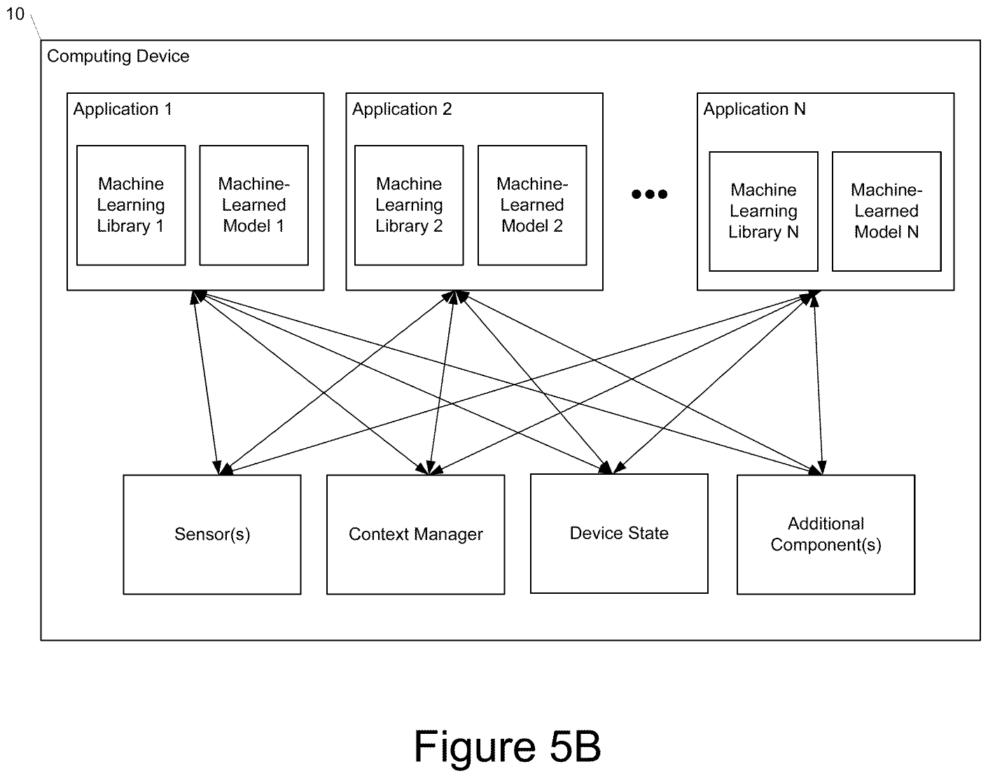

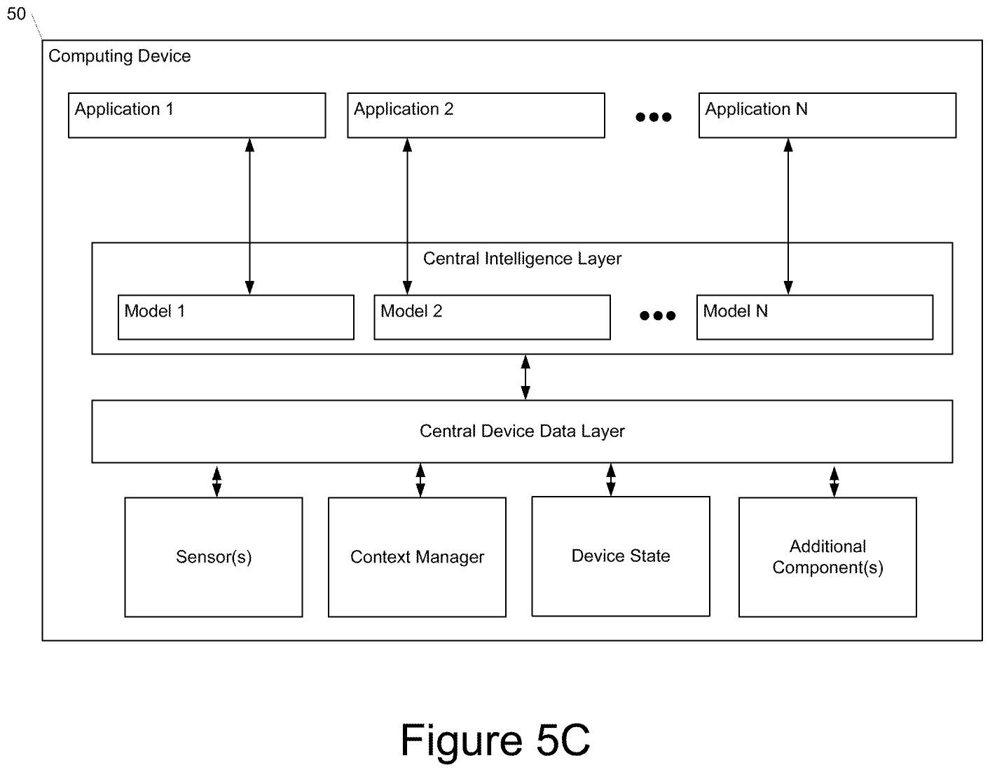

FIG. 5A depicts a block diagram of an example computing system 100 according to example implementations of the present disclosure. The system 100 includes a user computing device 102, a server computing system 130, and an automated machine learning system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120 and one or more deployment pipelines 121 that enable deployment of the models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 and corresponding origination and deployment pipelines are discussed with reference to FIGS. 1-4.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally, or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140 and one or more deployment pipelines 141 that enable deployment of the models 141. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 and corresponding origination and deployment pipelines are discussed with reference to FIGS. 1-4.

The user computing device 102 and/or the server computing system 130 can train the models 120 and/or 140 via interaction with the automated machine learning system 150 that is communicatively coupled over the network 180. The automated machine learning system 150 can be separate from the server computing system 130 or can be a portion of the server computing system 130.

The automated machine learning system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the automated machine learning system 150 to perform operations. In some implementations, the automated machine learning system 150 includes or is otherwise implemented by one or more server computing devices.

The automated machine learning system 150 can be in communication with a database 157 that contains datasets associated with a number of different tasks and/or domains. The database 157 can be used to provide an improved benchmarking system. The benchmarking system can be used with the automated model and pipeline generation tools described herein, but can also be used by any other models or systems. In particular, example model benchmarking systems provided by the present disclosure can include a large number (e.g., hundreds, thousands, etc.) of different datasets (e.g., training datasets, validation datasets, etc.) and associated metadata that correspond to a number of different machine-learning tasks (e.g., classification tasks, generative tasks, vision tasks, etc.) or domains (e.g., imagery, text, audio, natural language, sensor data, statistical data, etc.). As examples, the metadata associated with each dataset can include: (a) properties of the dataset; (b) problem statements; (c) feature engineering transformations; (d) hyperparameter search space; (e) training logs and signals; and/or (f) model quality metrics associated with each combination of hyperparameters.

These datasets can be stored in the database 157 and can be used to build a testing framework to test the quality of the automated machine learning system 150 in a rigorous and systematic way. For example, each time the automated machine learning system 150 is changed or altered, its performance can be measured against the datasets included in the database 157. For example, the performance of respective models automatically generated by the automated system can be measured against some portion (e.g., all) of the different tasks or domains. That is, a new version of an automated machine learning system 150 can be used to generate one or more new machine learning models for one or more datasets/tasks/domains included in the database 157. The performance of these models can be compared to the performance of other models generated by past versions of the system or other systems. The performance of the new models versus the previous models can be used as a proxy for measuring an improvement in or otherwise understanding the performance of the automated machine learning system 150.

In such fashion, the benchmarking tools described herein can provide for consistent and comparable performance benchmarking not only for specific models, but also for a larger system that seeks to automate aspects of the machine learning process (e.g., architecture searches, etc.). Furthermore, because the database 157 can include data for many different tasks or domains, the performance of the automated machine learning system 150 can be measured and optimized across such different tasks or domains or subsets thereof (e.g., user-defined subsets).

The automated machine learning system 150 can also include or be in communication with a meta-learning system 159. The meta-learning system 159 for automated machine learning system 150 can iteratively improve the automated machine learning system 150. More particularly, the automated machine learning system 150 can itself be considered to be meta-learning system 159 in which the automated machine learning system 150 is an “outer loop” that iteratively changes various aspects (e.g., architecture, hyperparameters, etc.) of the model training or generation process (i.e., the “inner loop” executed by model trainer 161) to optimize the model training or generation process, which in turn optimizes the final outputted model. The meta-learning system 159 described herein can be yet another “outer loop” around the automated machine learning system 150. For example, as described in the paragraphs above, a benchmarking system and database 157 can store hundreds or thousands of machine learning datasets for different tasks or domains. The meta-learning system 159 for automated machine learning system 150 can track metadata for every task such that the meta-learning system 159 can apply the principles of iterative testing, learning, and improvement on the automated machine learning system 150.

Thus, the parameters or hyperparameters (e.g., system settings such as, for example, number of training iterations) of the automated machine learning system 150 can be tuned (e.g., automatically tuned according to learning-based or black box optimization approaches) over time to continuously improve performance of the automated machine learning system and/or to enable high quality initial performance for new datasets. As one example, the meta-learning system 159 for automated machine learning system 150 can predict system settings for the automated machine learning system 150 to be applied to a new dataset based on characteristics of the new dataset. For example, statistical measures for the new dataset can be evaluated. Prior datasets that have similar statistical measures can be identified. The system settings that resulted in best performance for such prior datasets can be used as the initial settings for application of the automated machine learning system to the new dataset. For example, the system settings that resulted in best performance for such prior datasets can be averaged (e.g., a weighted average).

In a further example, the meta-learning system 159 for automated machine learning system 150 can include a machine-learned model (e.g., a neural network) that is trained to predict parameter or hyperparameter (e.g., system settings) for the automated machine learning system to be applied with respect to generation of a model for a new dataset. For example, the new dataset can be provided as input to the machine-learned model and, in one example, the machine-learned model can directly predict the hyperparameter values. In another example, the machine-learned model can generate a dataset embedding for the new dataset within an embedding space that encodes latent information about datasets. In such example, other previous datasets that have embeddings that are similar (e.g., close in distance measure) to the embedding generated for the new dataset can be identified. The system settings that resulted in best performance for such prior datasets can be used as the initial settings for application of the automated machine learning system to the new dataset. For example, the system settings that resulted in best performance for such prior datasets can be averaged (e.g., a weighted average).

In further examples, an ensemble of neural networks can be trained on a dataset of previously trained model hyper-parameters from all “related” prior searches. For example, each neural network in the ensemble can take as input a collection of tuples (e.g., model hyper-parameters, dataset properties), and output (predicted mean, predicted standard deviation) of the objective value. For example, each network can be trained to maximize the log likelihood of the true objective values of all trained models across all prior searches. In some implementations, each neural network can be trained separately from an independently sampled random initialization. At prediction time, the predictions of the neural networks can be ensembled to a single prediction. More precisely, in some examples, the ensemble distribution is a uniform mixture of Gaussian distributions, each of which is produced by a neural network. One example formula (via Bayesian model averaging) is: ensemble mean=mean of predicted means; ensemble standard deviation=mean of (predicted mean \hat{ }2+predicted standard deviation \hat{ }2)−ensemble mean \hat{ }2. The more disagreement there is among the ensemble members, the higher ensemble standard deviation will be, as desired.

The automated machine learning system 150 can include an origination pipeline 160. The origination pipeline 160 can be used to generate the models and/or deployment pipelines. The origination pipeline 160 can operate as described with reference to FIG. 1 and/or FIG. 2.

The automated machine learning system 150 can include a model trainer 161 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 161 can perform a number of generalization techniques (e.g., weight decays, dropouts, etc.) to improve the generalization capability of the models being trained.

In particular, the model trainer 161 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the automated machine learning system 150 on user-specific data received from the user computing device 102. In some instances, this process can be referred to as personalizing the model.

The model trainer 161 includes computer logic utilized to provide desired functionality. The model trainer 161 can be implemented in hardware, firmware, and/or software controlling a general-purpose processor. For example, in some implementations, the model trainer 161 includes program files stored on a storage device, loaded into a memory and executed by one or more processors. In other implementations, the model trainer 161 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data, and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 5A illustrates one example computing system that can be used to implement the present disclosure. Other computing systems can be used as well. For example, in some implementations, the user computing device 102 can include the model trainer 161 and the training dataset 162. In such implementations, the models 120 can be both trained and used locally at the user computing device 102. In some of such implementations, the user computing device 102 can implement the model trainer 161 to personalize the models 120 based on user-specific data.

FIG. 5B depicts a block diagram of an example computing device 10 that performs according to example implementations of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example implementations of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example implementations thereof, each example is provided by way of explanation, not limitation of the disclosure. Those skilled in the art, upon attaining an understanding of the foregoing, can readily produce alterations to, variations of, and equivalents to such implementations. Accordingly, the subject disclosure does not preclude inclusion of such modifications, variations and/or additions to the present subject matter as would be readily apparent to one of ordinary skill in the art. For instance, features illustrated or described as part of one implementation can be used with another implementation to yield a still further implementation. Thus, it is intended that the present disclosure cover such alterations, variations, and equivalents.

What is claimed is:

1. A computing system for automatic production of machine learning models and corresponding deployment pipelines, the computing system comprising:
one or more processors; and
one or more non-transitory computer-readable media that collectively store instructions that, when executed by the one or more processors, cause the computing system to perform operations, the operations comprising:
importing a training dataset associated with a user;
executing an origination machine learning pipeline to:
perform a model architecture search that selects and trains a machine learning model for the training dataset; and
generate a deployment machine learning pipeline for deployment of the machine learning model; and
exporting the machine learning model and the deployment machine learning pipeline for deployment of the machine learning model with the deployment machine learning pipeline.

2. The computing system of claim 1, wherein:
the training dataset comprises a structured training dataset having data associated with a number of labels; and
the operations further comprise receiving a selection from the user of one of the labels as a predicted label to be predicted by the machine learning model.

3. The computing system of claim 1, wherein the operations further comprise:
receiving a problem statement from the user, wherein the problem statement is expressed in a natural language; and
inferring, based on the problem statement, one or more parameters of an optimization domain associated with the model architecture search performed by the origination machine learning pipeline.

4. The computing system of claim 1, wherein said operations of importing and exporting are performed via a programmatic application programming interface.

5. The computing system of claim 1, wherein executing the origination machine learning pipeline to perform the model architecture search comprises:
detecting a semantic type for one or more features of a plurality of features included in the training dataset; and
constraining the model architecture search to candidate model architectures capable of processing the semantic type detected for the one or more features of the plurality of features included in the training dataset.

6. The computing system of claim 1, wherein executing the origination machine learning pipeline to perform the model architecture search comprises:
generating one or more statistics descriptive of the training dataset; and
predicting one or more system settings of the model architecture search based on the one or more statistics descriptive of the training dataset.

7. The computing system of claim 6, wherein predicting one or more system settings of the model architecture search based on the one or more statistics descriptive of the training dataset comprises processing data descriptive of the one or more statistics with a machine-learned settings prediction model to directly predict the system settings as an output of the machine-learned settings prediction model.

8. The computing system of claim 1, wherein executing the origination machine learning pipeline to perform the model architecture search comprises:
generating one or more statistics descriptive of the training dataset;
identifying, based on the one or more statistics descriptive of the training dataset, one or more previous searches performed on one or more previous datasets that have statistics similar to the statistics of the training dataset; and
defining one or more system settings of the model architecture search based on previous system settings identified for the one or more previous searches.

9. The computing system of claim 1, wherein the operations further comprise:
storing metadata descriptive of the training dataset and performance of the model architecture search; and
tuning one or more parameters of the origination machine learning pipeline based on the metadata descriptive of the training dataset and performance of the model architecture search.

10. The computing system of claim 1, wherein the operations further comprise identifying one or more correlations between feature crosses and labels of the training dataset.

11. The computing system of claim 1, wherein the deployment machine learning pipeline comprises both:
a fixed feature training component configured to retrain the machine learning model with a fixed list of feature columns; and
a re-tuning component configured to perform a second model architecture search to identify a new machine learning model for the training dataset.

12. A computer-implemented method for automatic production of machine learning models and corresponding deployment pipelines, the method performed by one or more computing devices and comprising:
importing a training dataset associated with a user;
executing an origination machine learning pipeline, wherein executing the origination machine learning pipeline comprises:
performing a model architecture search that selects and trains a machine learning model for the training dataset; and
generating a deployment machine learning pipeline for deployment of the machine learning model; and
exporting the machine learning model and the deployment machine learning pipeline for deployment of the machine learning model with the deployment machine learning pipeline.

13. The computer-implemented method of claim 12, wherein:
the training dataset comprises a structured training dataset having data associated with a number of labels; and
the method further comprises receiving a selection from the user of one of the labels as a predicted label to be predicted by the machine learning model.

14. The computer-implemented method of claim 12, wherein the method further comprises:
receiving a problem statement from the user, wherein the problem statement is expressed in a natural language; and
inferring, based on the problem statement, one or more parameters of an optimization domain associated with the model architecture search performed by the origination machine learning pipeline.

15. The computer-implemented method of claim 12, wherein said importing and exporting are performed via a programmatic application programming interface.

16. The computer-implemented method of claim 12, wherein executing the origination machine learning pipeline to perform the model architecture search comprises:
detecting a semantic type for one or more features of a plurality of features included in the training dataset; and
constraining the model architecture search to candidate model architectures capable of processing the semantic type detected for the one or more features of the plurality of features included in the training dataset.

17. The computer-implemented method of claim 12, wherein executing the origination machine learning pipeline to perform the model architecture search comprises:
generating one or more statistics descriptive of the training dataset; and
predicting one or more system settings of the model architecture search based on the one or more statistics descriptive of the training dataset.

18. The computer-implemented method of claim 17, wherein predicting one or more system settings of the model architecture search based on the one or more statistics descriptive of the training dataset comprises processing data descriptive of the one or more statistics with a machine-learned settings prediction model to directly predict the system settings as an output of the machine-learned settings prediction model.

19. The computer-implemented method of claim 12, wherein the deployment machine learning pipeline comprises both:
a fixed feature training component configured to retrain the machine learning model with a fixed list of feature columns; and
a re-tuning component configured to perform a second model architecture search to identify a new machine learning model for the training dataset.

20. One or more non-transitory computer-readable media that collectively store instructions that, when executed by one or more processors of a computing system, cause the computing system to perform operations, the operations comprising:
importing a training dataset associated with a user;
executing an origination machine learning pipeline to:
perform a model architecture search that selects and trains a machine learning model for the training dataset; and
generate a deployment machine learning pipeline for deployment of the machine learning model; and
exporting the machine learning model and the deployment machine learning pipeline for deployment of the machine learning model with the deployment machine learning pipeline.
